(19) United States
(12) Patent Application Publication
(10) Pub. No.: US 2009/0278751 A1
(43) Pub. Date: Nov. 12, 2009

(54) Antenna Device and Portable Terminal Device

(75) Inventor: Takayuki Nebashi, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto (JP)

(21) Appl. No.: 12/306,905

(22) PCT Filed: Jun. 29, 2007
(86) PCT No.: PCT/JP2007/063140

§ 371 Date: Dec. 29, 2008

(30) Foreign Application Priority Data
Jun. 29, 2006 (JP) 2006-179616

(51) Int. Cl. H01Q 1/24; H01Q 1/12

(52) U.S. Cl. 343/702; 343/878

(57) ABSTRACT

An antenna device and a portable terminal device bringing only part of an antenna conductor into contact with a board so as to keep loss due to a dielectric material to a minimum and to achieve smaller size and lighter weight, including a planar circuit board (1) on which a high frequency transmitting/receiving circuit is mounted and a strip-shaped or wire-shaped antenna conductor (2) which is partly supported over an end portion of the circuit board (1) and has a necessary wavelength for the frequency used.

### TECHNICAL FIELD

The present invention relates to an antenna device suitable for use for a built-in antenna of a mobile phone or other portable terminal and to a portable terminal device.

### BACKGROUND ART

In a mobile phone or car-equipped device or other portable terminal device, small size, light weight, and high performance type antenna devices have been demanded.

For example, among mobile phones circulating on the market, ones employing a diversity system provided with two types of antennas, that is, a whip antenna used for both transmission and reception and a built-in antenna dedicated to reception, have increased.

In this case, monopole antennas are being widely used as the whip antennas, and inverse F type antennas, chip antennas using ceramics, etc. are being widely used as the built-in antennas.

All employ technology making them smaller in size and lighter in weight and, at the same time, making them higher in performance and broader in band. Many such technologies have been proposed.

For example, the technology of using a board and bent sheet metal to realize a slot antenna and thereby realize smaller size and a greater thinness while maintaining a high transmission/reception performance (see for example Patent Document 1), the technology of using a through-hole and conductor pattern at a circumferential edge of the board and forming a helical pattern to raise the output to the highest limit (see for example Patent Document 2), etc. are known.

Patent Document 1: Japanese Patent Publication (A) No. 7-193416

Patent Document 2: Japanese Patent Publication (A) No. 9-71189

### DISCLOSURE OF THE INVENTION

### Problem to be Solved by the Invention

However, if using a chip antenna for a built-in antenna, there is no gain unless using parts having a large volume. While depending on the mounting space, it cannot be mounted except at the board, so there is a limit in securing volume.

Further, in order to solve this, there is also an antenna configured by attaching sheet metal to a housing and bringing it into contact with an antenna portion of the board.

In this case, however, design for attachment to the housing side became necessary. Further, conduction between the antenna and the board side could not be confirmed at a contact point with the board unless assembled in the housing.

Further, according to the technology disclosed in Patent Document 1, a dielectric material is attached to the antenna to make the wavelength seem longer. However, it cannot be immediately learned up to which frequency it can handle. Further, design in a case where the shape of the set and installation space differ and so on is difficult.

Further, according to the technology disclosed in Patent Document 2, when mounting the antenna at a circumferential edge of the board, if forming the antenna conductor contributing to emission on the board or in contact with the board, there was the defect that emission power was lost and the performance was degraded.

The present invention provides an antenna device and a portable terminal device bringing only part of the antenna conductor into contact with the board so as to keep loss due to a dielectric material to a minimum and achieve smaller size and lighter weight.

### Means for Solving the Problem

An antenna device of a first aspect of the present invention has a circuit board on which a high frequency transmitting/receiving circuit is mounted and an antenna conductor formed by a conductor element which is partly supported over an end portion of the circuit board and has a folded shape having a necessary wavelength worth of length for the frequency used.

Preferably, in the antenna conductor, the conductor element supported on the circuit board includes a meandering shape.

Preferably, the antenna conductor is supported on the circuit board by a spring contact formed by bending a meander portion having a meandering shape in the conductor element.

Preferably, the antenna conductor is a monopole antenna in which the conductor element is arranged on the circuit board, and power is supplied with the end portion of the conductor element.

Preferably, the antenna conductor is a dipole antenna in which the strip-shaped conductor element is arranged on the circuit board, and power is supplied with the vicinity of the center portion of the conductor element.

Preferably, the circuit board is formed with a power supply part supplying power by contact of the spring contact by which the conductor element is supported over the end portion of the circuit board.

Preferably, the conductor element is formed with a wedge portion, the circuit board is formed with a conduction hole into which the wedge portion can be inserted, and the conductor element is affixed by the wedge portion being inserted into the conduction hole formed in the circuit board.

A portable terminal device of a second aspect of the present invention has a circuit board on which high frequency circuit parts are mounted and an antenna device, the antenna device including an antenna conductor formed by a conductor element which is partly supported over an end portion of the circuit board and has a folded shape having a necessary wavelength worth of length for the frequency used.

### Effect of the Invention

According to the present invention, an antenna device and a portable terminal device bringing only part of the antenna conductor into contact with the board so as to keep loss due to a dielectric material to a minimum and achieve smaller size and lighter weight can be provided.

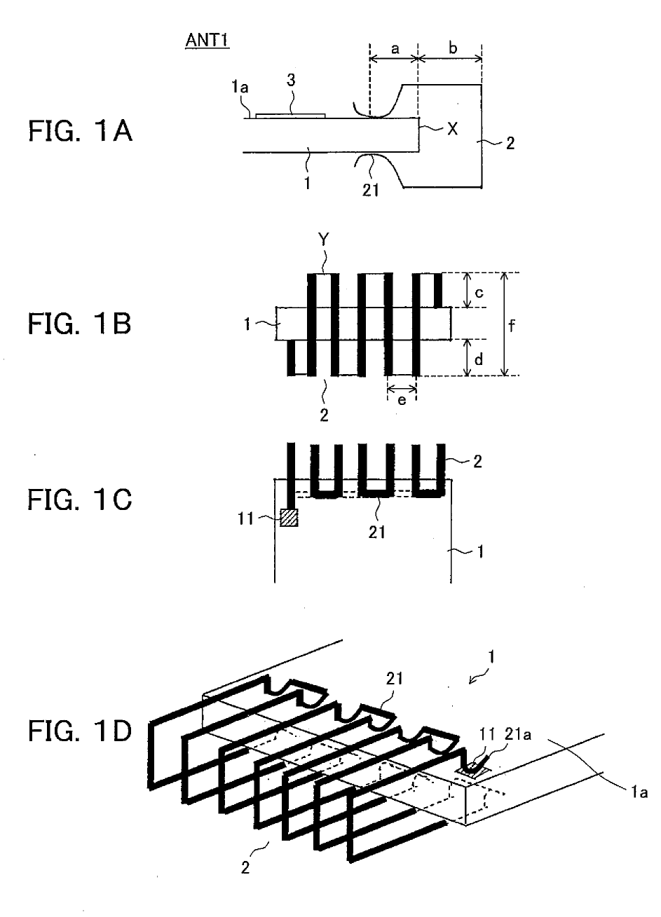

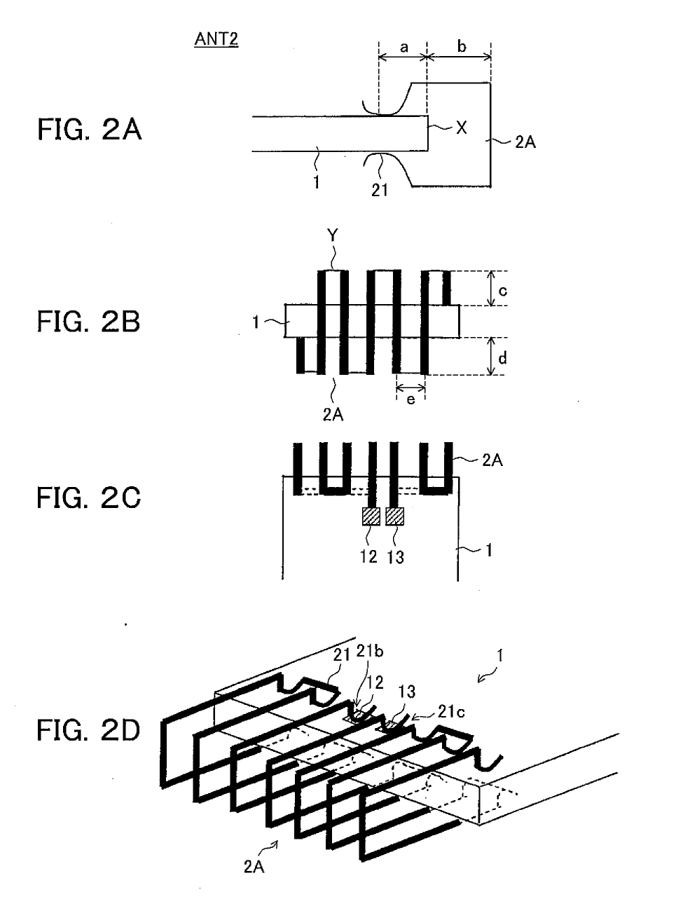

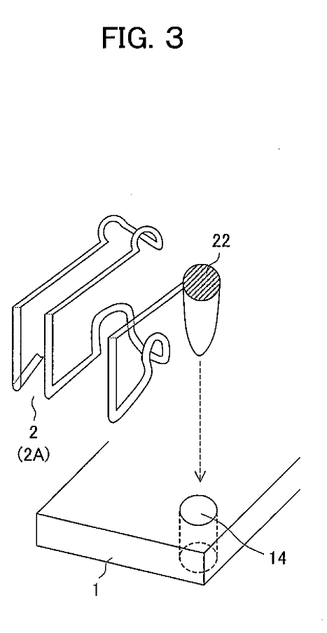

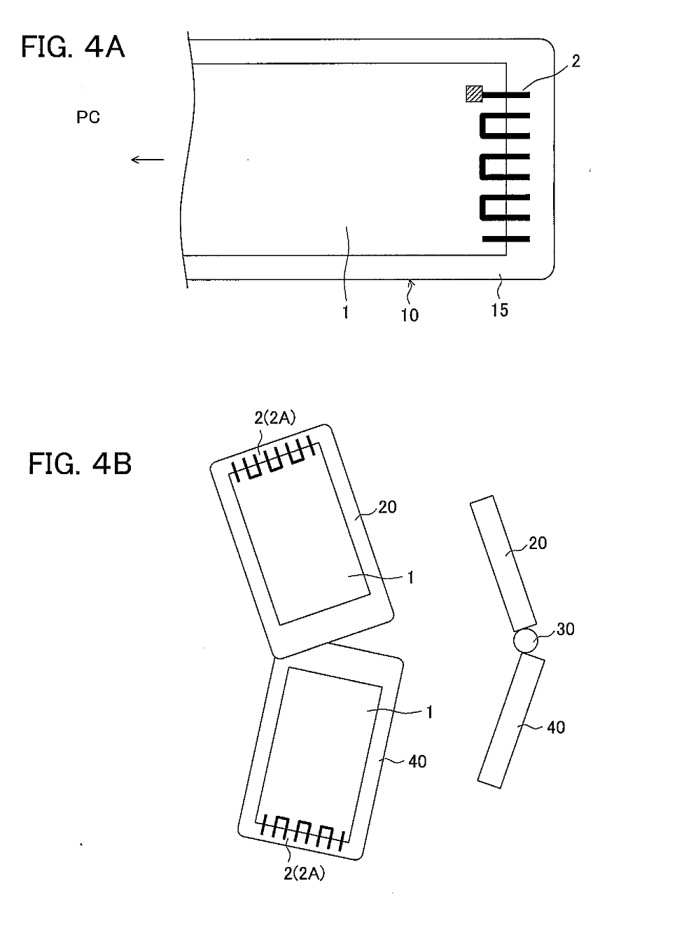

### BRIEF DESCRIPTION OF THE DRAWINGS

[FIGS. 1] FIG. 1A to FIG. 1D are views of the configuration of an antenna device according to a first embodiment of the present invention.

[FIGS. 2] FIG. 2A to FIG. 2D are views of the configuration of an antenna device according to a second embodiment of the present invention.

[FIG. 3] FIG. 3 is a diagram for explaining a method of affixing an antenna conductor to a circuit board 1 in the antenna device in the embodiment of the present invention.

[FIGS. 4] FIG. 4A and FIG. 4B are diagrams for explaining the configuration of a portable terminal device mounting the antenna device according to an embodiment of the present invention.

### BEST MODE FOR CARRYING OUT THE INVENTION

FIG. 1A to FIG. 1D are views of the configuration of an antenna device according to a first embodiment of the present invention and show an example of the configuration of a monopole antenna.

FIG. 1A is a side view of the monopole antenna according to the first embodiment, FIG. 1B is a front view of the same, FIG. 1C is a plan view of the same, and FIG. 1D is a perspective view of the same.

This monopole type antenna device ANT1 is comprised of a circuit board 1 forming, for example, a planar shape on which an antenna conductor 2 formed by folding a strip-shaped or wire-shaped conductor a predetermined number of times is arranged and is supplied with power at an end portion of the antenna conductor 2.

As shown in FIGS. 1A to 1D, the circuit board 1 is formed by a planar dielectric material. For example, on a main surface 1a of the circuit board 1, a circuit part 3 including a high frequency transmitting/receiving circuit is mounted. On the circuit board 1, further an antenna conductor 2 formed so as to be folded and partly supported over an edge portion X of the circuit board 1 is formed.

Here, the antenna conductor 2 has a meandering shaped conductor pattern. By bending that meander portion Y (folded portion) toward the inside of a thickness direction f of the antenna conductor 2, in other words, bending it in the board surface direction when attaching it to the circuit board 1, one or more spring contacts 21 are formed. The conductor is supported on the circuit board 1 by the spring contacts 21.

A transmission efficiency or reception efficiency of the antenna device ANT1 is defined by the ratio between the wavelength of the signal used and antenna length. Here, it is possible to change the dimensions of the antenna conductor 2 indicated by notations a to e in FIG. 1A and FIG. 1B and the number of meanderings (number of turns) of the meandering shape antenna conductor 2 so as to change the shape of the antenna conductor 2 and possible to construct an antenna conductor 2 having a wavelength matching with the used frequency of the signal.

Note that, the power supply part 11 at the circuit board 1 supplies power by contact or coupling with the spring contacts 21a formed while supporting the antenna conductor 2 over the end portion of the circuit board 1.

In this example, the power supply part 11 is formed on the main surface 1a of the circuit board 1 at the edge portion X side at one end side of this edge portion X.

FIG. 2A to FIG. 2D are views of the configuration of an antenna device according to a second embodiment of the present invention and show an example of the configuration of a dipole antenna.

FIG. 2A is a side view of the dipole antenna according to the second embodiment, FIG. 2B is a front view of the same, FIG. 2C is a plan view of the same, and FIG. 2D is a perspective view of the same.

The difference of the dipole antenna ANT2 according to the second embodiment from the monopole antenna ANT1 according to the first embodiment resides in the point that the power is supplied at the antenna conductor 2A not by one power supply part 11, but by two power supply parts 12 and 13.

Here, other than the power supply by the power supply parts 12 and 13, there is no difference from the monopole system described above. Therefore the explanation is omitted in the sense of avoiding overlap.

The power supply parts 12 and 13 are formed on the main surface 1a of the circuit board 1 at the edge portion X side not at one end side of this edge portion X, but at the center portion of this edge portion X.

Further, the antenna conductor 2A is supplied with electric power by contact or coupling of two contact part 21b and 21c of the antenna conductor 2A with the power supply parts 12 and 13.

According to the antenna devices ANT1 and ANT2 of the above embodiments of the present invention, by bringing only parts of the antenna conductors 2 and 2A into contact with the board, attachment of the antenna conductor 2 to the housing is unnecessary. The assembly is completed by just the circuit board 1. Therefore, checking of conduction between the antenna conductor 2 and the circuit board 1 and so on become easy.

Further, the antenna conductors 2 and 2A may be designed by the necessary wavelength worth of lengths, therefore it is easy to obtain a general rule for design. Further, empty space can be utilized to the maximum limit and the maximum limit of gain of the emission power can be secured without changing the antenna length by changing the distance from the circuit board 1 according to the position or the like.

Note that, according to the embodiments of the present invention described above, only the example of forming a strip-shaped antenna conductor 2 on the circuit board 1 was shown. However, the same effects are obtained even when forming a wire-shaped antenna conductor and using it as a monopole or dipole type antenna.

FIG. 3 is a diagram used for explaining a method of affixing an antenna conductor 2 to a circuit board 1 in an antenna device in an embodiment of the present invention. FIG. 3 shows a method of affixing a monopole antenna.

As described above, according to the antenna device of the embodiment of the present invention, the one or more spring contacts 21 formed in the meandering portion Y of the antenna conductor 2 having a meandering shape are used for support over the end portion of the circuit board 1.

However, with this alone, the mounting structure is liable to become unstable. Therefore, as shown in FIG. 3, in the monopole antenna, it is possible to insert a wedge portion 22 formed at the end portion of the antenna conductor 2 into a conduction hole 14 formed in the circuit board 1 facing this wedge portion 22 to affix it.

According to the embodiment of the present invention described above, by fitting and affixing the antenna conductors 2 and 2A to the circuit board 1 in addition to supporting them by the spring contacts 21, an antenna device which is structurally stable can be provided.

Note that, according to the embodiment of the present invention described above, an explanation was given of only support by the spring contacts 21 shown in FIG. 1 and FIG. 2 and fitting and affixing to the circuit board 1 shown in FIG. 3. However, the invention is not limited to these. The methods of soldering the antenna conductor 2, affixing using an epoxy resin or a binder, and so on can be employed.

FIG. 4A and FIG. 4B are diagrams used for explaining the configuration of a portable terminal device mounting an antenna device according to an embodiment of the present invention. They are used for explaining examples of the configuration when mounting the antenna device on a card terminal and a mobile phone terminal.

In FIG. 4, the same components as those of FIG. 1 and FIG. 2 are assigned the same notations in order to facilitate understanding.

A wireless card 10 shown in FIG. 4A is for example a card the same as a card mounted in a card slot of a personal computer (PC) or the like.

A strip-shaped antenna device (monopole antenna) having a meandering shape described above is mounted at the end portion of the circuit board 1 mounted on a card case 15.

Further, in a flip-open type mobile phone terminal shown in FIG. 4B, a strip-shaped built-in antenna (monopole antenna) having a meandering shape described above is mounted at each of end portions of a first (upper side) housing 20 in which a circuit board 1 including an LCD (liquid crystal display) monitor is mounted and a second (lower side) housing 40 which is connected with this first (upper side) housing 20 through a hinge 30 and in which a key switch or other circuit board 1 is mounted.

According to the portable terminal device of the present invention described above, by bringing only a part of the antenna conductor into contact with the board, a small, light weight, and high performance type portable terminal device mounting a built-in antenna keeping loss due to a dielectric material to a minimum and formed compact can be provided.

### INDUSTRIAL APPLICABILITY

According to the present invention, it is possible to form a small, light weight, and high performance device mounting a built-in antenna keeping loss due to a dielectric material to a minimum and formed compact, therefore this can be applied to a mobile phone or other portable terminal device.

1. An antenna device, comprising:
a circuit board on which a high frequency transmitting/receiving circuit is mounted and
an antenna conductor formed by a conductor element which is partly supported over an end portion of the circuit board and has a folded shape having a necessary wavelength worth of length for the frequency used.

2. An antenna device as set forth in claim 1, in which antenna conductor, the conductor element supported on the circuit board includes a meandering shape.

3. An antenna device as set forth in claim 2, wherein the antenna conductor is supported on the circuit board by a spring contact formed by bending a meander portion having a meandering shape in the conductor element.

4. An antenna device as set forth in claim 1, wherein the antenna conductor is a monopole antenna in which the conductor element is arranged on the circuit board, and power is supplied with the end portion of the conductor element.

5. An antenna device as set forth in claim 1, wherein the antenna conductor is a dipole antenna in which the strip-shaped conductor element is arranged on the circuit board, and power is supplied with the vicinity of the center portion of the conductor element.

6. An antenna device as set forth in claim 3, wherein the circuit board is formed with a power supply part supplying power by contact of the spring contact by which the conductor element is supported over the end portion of the circuit board.

7. An antenna device as set forth in claim 4, wherein the circuit board is formed with a power supply part supplying power by contact of the spring contact by which the conductor element is supported over the end portion of the circuit board.

8. An antenna device as set forth in claim 5, wherein the circuit board is formed with a power supply part supplying power by contact of the spring contact by which the conductor element is supported over the end portion of the circuit board.

9. An antenna device as set forth in claim 1, wherein
the conductor element is formed with a wedge portion,
the circuit board is formed with a conduction hole into which the wedge portion can be inserted, and
the conductor element is affixed by the wedge portion being inserted into the conduction hole formed in the circuit board.

10. A portable terminal device, comprising:
a circuit board on which high frequency circuit parts are mounted and
an antenna device,
the antenna device including an antenna conductor formed by a conductor element which is partly supported over an end portion of the circuit board and has a folded shape having a necessary wavelength worth of length for the frequency used.

11. A portable terminal device as set forth in claim 10, wherein the antenna conductor is supported on the circuit board by a spring contact formed by bending a meander portion having a meandering shape in the conductor element.

12. A portable terminal device as set forth in claim 10, wherein the antenna conductor is a monopole antenna in which the conductor element is arranged on the circuit board, and power is supplied with the end portion of the conductor element.

13. A portable terminal device as set forth in claim 10, wherein the antenna conductor is a dipole antenna in which the strip-shaped conductor element is arranged on the circuit board, and power is supplied with the vicinity of the center portion of the conductor element.

14. A portable terminal device as set forth in claim 11, wherein the circuit board is formed with a power supply part supplying power by contact of the spring contact by which the conductor element is supported over the end portion of the circuit board.

15. A portable terminal device as set forth in claim 10, wherein:
the conductor element is formed with a wedge portion,
the circuit board is formed with a conduction hole into which the wedge portion can be inserted, and
the conductor element is affixed by the wedge portion being inserted into the conduction hole formed in the circuit board.
